(19) United States
(12) Patent Application Publication
(10) Pub. No.: US 2026/0242145 A1
(43) Pub. Date: Aug. 20, 2026

(54) Flip Rail for Conveyor System

(71) Applicant: Modo 8, LLC, Beloit, WI (US)

(72) Inventors: Tony Alan Hill, Cape Coral, FL (US); Nicolas Todd Marois, Janesville, WI (US)

(21) Appl. No.: 19/462,335

(22) Filed: Jan. 28, 2026

Related U.S. Application Data
(60) Provisional application No. 63/750,392, filed on Jan. 28, 2025.

(51) Int. Cl. B65G 13/11; B65G 39/12

(52) U.S. Cl. CPC B65G 13/11; B65G 39/12

(57) ABSTRACT

A rail for a conveyor system having rollers includes a mounting wall with a first set of openings formed adjacent a first edge of the mounting wall at a distance greater than a diameter of the rollers of the conveyor system and a second set of openings formed adjacent a second edge of the mounting wall at a distance less than or equal to the diameter of the rollers of the conveyor system. The first set of openings are configured to exclusively receive the rollers of the conveyor system in a first configuration of the rail, while the second set of openings are configured to exclusively receive the rollers of the conveyor system in a second orientation of the rail.

### CROSS-REFERENCE TO RELATED APPLICATIONS

This application claims priority to U.S. Provisional Application No. 63/750,392, filed on Jan. 28, 2025, the entire contents of which are incorporated herein by reference.

### BACKGROUND OF THE INVENTION

### 1. Field of the Invention

The present invention relates to a flip rail for a conveyor system that is configured to be installed in either a high setting and a low setting.

### 2. Discussion of the Related Art

It is known in the art that conveyor system are set up with side rails that receive and support the ends of the conveyor mechanism of the conveyor system, e.g., rollers. Side rails are manufactured to have one set of openings formed therein to allow for the conveyor mechanism to attach to the side rails at predetermined locations. However, side rails in the art only have a single vertical location for such an attachment.

There is a need in the art for a conveyor system rail that can be installed in more than one configuration to allow for the conveyor system to have a side guard rail preventing materials from overhanging the edge of the conveyor system or to not have a side guard rail and allow packages wider than the conveyor system to traverse the conveyor system. It is beneficial to have a single flip rail in order to allow minimal parts for each configuration.

### SUMMARY OF THE INVENTION

The present invention is directed to a flip rail for a conveyor system that is configured to be installed in one of a high setting and a low setting.

According to an embodiment of the invention, a rail for a conveyor system having rollers includes a mounting wall with a first set of openings formed adjacent a first edge of the mounting wall at a distance greater than a diameter of the rollers of the conveyor system and a second set of openings formed adjacent a second edge of the mounting wall at a distance less than or equal to the diameter of the rollers of the conveyor system. The first set of openings are configured to exclusively receive the rollers of the conveyor system in a first configuration of the rail, while the second set of openings are configured to exclusively receive the rollers of the conveyor system in a second orientation of the rail. Further, the rail includes a first wall extending outward from the first edge of the mounting wall and a second wall extending outward from the second edge of the mounting wall.

In accordance with another embodiment of the invention, the first wall is oriented upward and the second wall is oriented downward in the first configuration. Meanwhile, the second wall is oriented upward and the first wall is oriented downward in the second configuration. In turn, a top surface of the rollers is disposed below a top surface of the first wall in the first configuration, while a top surface of the rollers is disposed above a top surface of the second wall in the second configuration. Preferably, the first set of openings are formed at a distance greater than 2 inches from the first edge of the mounting wall, while the second set of openings are formed at a distance less than 1 inch from the second edge of the mounting wall.

In accordance with yet another aspect of the invention, a first extension wall extends perpendicularly from a cantilevered end of the first wall in a direction toward the second wall. Similarly, a second extension wall extends perpendicularly from a cantilevered end of the second wall in a direction toward the first wall. The first and second extension walls are oriented parallel to each other. Preferably, the first and second extension walls are oriented along the same plane.

According to another embodiment of the invention, a method of installing a conveyor system includes installing a plurality of rails with each rail including a mounting wall having a first wall extending from a first edge and a second wall extending from a second edge, a first set of openings formed in the mounting wall adjacent a first edge of the mounting wall at a distance greater than a diameter of rollers of the conveyor system, and a second set of openings formed in the mounting wall adjacent a second edge of the mounting wall at a distance less than or equal to the diameter of the rollers of the conveyor system. In a first configuration, the method further includes installing a plurality of rollers of the conveyor system exclusively in the first set of openings. Conversely, in a second configuration, the method further includes installing the plurality of rollers of the conveyor system exclusively in the second set of openings.

In accordance with another aspect of the invention, in the first configuration, the method further includes installing the plurality of rails with the first wall oriented upward and the second wall oriented downward. Conversely, in the second configuration, the method further includes installing the plurality of rails with the second wall oriented upward and the first wall oriented downward.

In accordance with yet another aspect of the invention, in the first and second configurations, installing the plurality of rollers of the conveyor system includes extending the plurality of rollers between adjacent rails. When installing the plurality of rollers of the conveyor system in the first configuration, each roller of the plurality of rollers is installed between aligned openings in the first set of openings to orient the rollers perpendicular to the adjacent rails. Meanwhile, when installing the plurality of rollers of the conveyor system in the first configuration, each roller of the plurality of rollers is installed between aligned openings in the second set of openings to orient the rollers perpendicular to the adjacent rails.

According to yet another embodiment of the invention, a conveyor system includes a plurality or rollers extending between at least two rails. Each rail includes a first set of openings formed adjacent a first edge of the mounting wall at a distance greater than a diameter of the plurality of rollers of the conveyor system and a second set of openings formed adjacent a second edge of the mounting wall at a distance less than or equal to the diameter of the plurality of rollers of the conveyor system. The first set of openings are configured to exclusively receive the plurality of rollers of the conveyor system in a first configuration of the rail, while the second set of openings are configured to exclusively receive the plurality of the rollers of the conveyor system in a second orientation of the rail. Each rail further includes a first wall extending outward from the first edge of the mounting wall and a second wall extending outward from the second edge of the mounting wall.

In accordance with another aspect of the invention, the first wall of each rail is oriented upward and the second wall of each rail is oriented downward in the first configuration. Conversely, the second wall of each rail is oriented upward and the first wall of each rail is oriented downward in the second configuration. In the first configuration, a top surface of the first wall of each rail is located above a top surface of the rollers. Preferably, the top surface of the first wall of each rail is located above the top surface of the rollers by 1 to 2 inches. In the second configuration, a top surface of the second wall of each rail is locate below a top surface of the rollers in the second configuration.

In accordance with yet another aspect of the invention, in the first configuration, each roller of the plurality of rollers extends between aligned openings in the first set of openings to orient the rollers perpendicular to the adjacent rails. Meanwhile, in the second configuration, each roller of the plurality of rollers extends between aligned openings in the second set of openings to orient the rollers perpendicular to the adjacent rails.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an isometric view of a flip rail, according to the invention;

FIG. 2 is a top view of the flip rail of FIG. 1;

FIG. 3 is a side view of the flip rail of FIG. 1 in a first configuration;

FIG. 4 is a bottom view of the flip rail of FIG. 1;

FIG. 5 is a side view of the flip rail of FIG. 1 in a second configuration;

FIG. 6 is a front view of the flip rail of FIG. 1;

FIG. 7 is an isometric view of a conveyor system with the flip rail installed in the first configuration; and

FIG. 8 is an isometric view of a conveyor system with the flip rail installed in the second configuration.

### DETAILED DESCRIPTION OF THE INVENTION

The present invention and the various features and advantageous details thereof are explained more fully with reference to the non-limiting embodiments described in detail in the following description.

Throughout this description, various terms denoting direction, such as left and right, front and rear, up and down, top and bottom, and the like may be used. The directions are not intended to be limiting but are used to describe relationships of elements with respect to each other in the accompanying drawings. Unless mutually exclusive, it is contemplated that the elements may be reversed, for example, by turning a component around or upside down without deviating from the scope of the present invention.

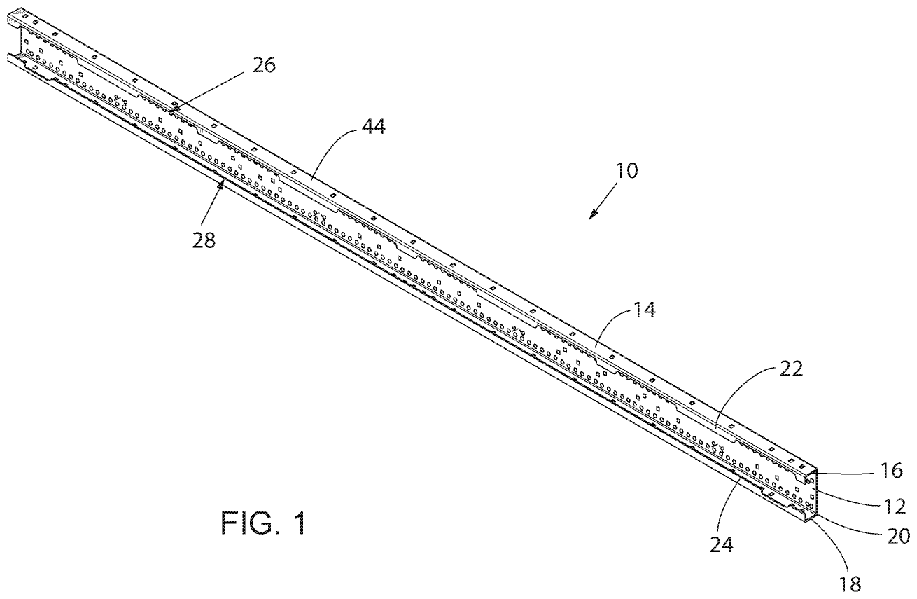

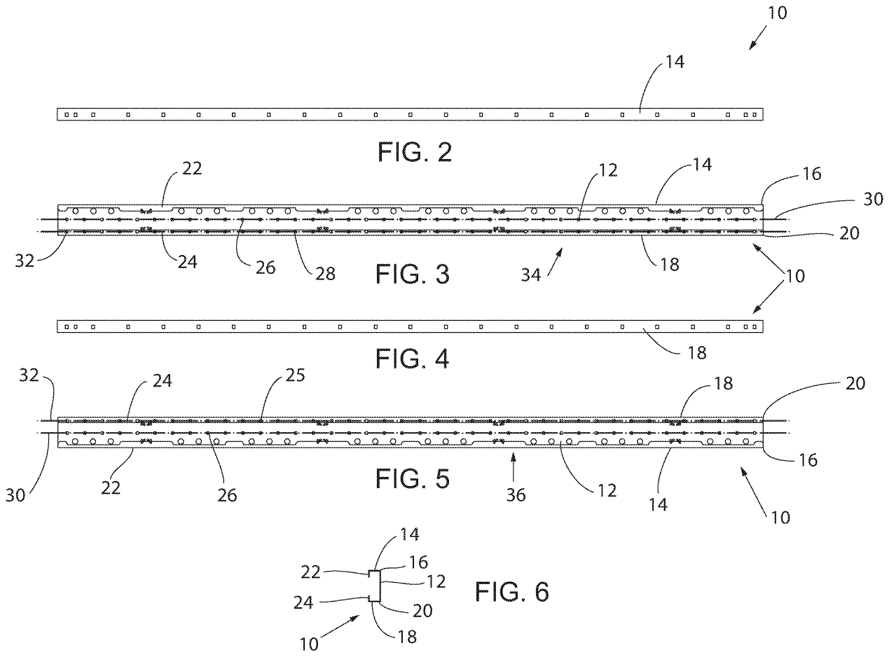

Turning initially to FIGS. 1-6, a flip rail 10 is shown in accordance with an embodiment of the invention. The flip rail 10 may be in the form of a C-channel metal rail having a mounting wall 12 oriented in a vertical direction or substantially in the vertical direction. The flip rail 10 includes a first, top wall 14 extending outward and perpendicular from a first, top end 16 of the mounting wall 12 and a second, bottom wall 18 extending outward and perpendicular from a second, bottom end 20 of the mounting wall 12. That is, in the representative embodiment of the invention shown in FIG. 5, the top and bottom walls 14, 18 extend in the same direction from the mounting wall 12 and are oriented parallel to each other. The top wall 14 may further include a top extension wall extending perpendicularly from a cantilevered end thereof in a direction toward the bottom wall 18. Similarly, the bottom wall 18 may further include a bottom extension wall 24 extending perpendicular from a cantilevered end thereof in a direction toward the top wall 14 to form the C-channel shape shown in FIG. 6. In turn, the top and bottom extension walls 22, 24 extend parallel to each other and not beyond the top and bottom walls 14, 18 of the rail 10. Preferably, the top and bottom extension walls 22, 24 are oriented along the same plane. As a result, the top and bottom extension walls 22, 24 are spaced oriented parallel to the mounting wall 12 and spaced apart therefrom by a distance equal to a length of the top and bottom walls 14, 18, respectively.

As shown in FIGS. 3 and 5, the mounting wall 12 includes a first set of openings 26 formed therein and a second set of openings 28 formed therein. The first set of openings 26 are formed along a first horizontal axis 30 and spaced apart from each other preferably by 3 inches. The second set of openings 28 are formed along a second horizontal axis 32 and also spaced apart from each other preferably by 3 inches. The first and second horizontal axis 30, 32 are spaced apart from each other and oriented parallel to each other. As discussed in further detail below, FIGS. 3 and 5 illustrate the first set of openings 26 as being spaced further from the first wall 14 of the flip rail 10 than the second set of openings 28 are spaced from the second wall 18 of the flip rail 10. In other words, the second set of openings 28 are closer to the second wall 18 than the first set of openings are to the first wall 14. Additionally, the first set of openings 26 are closer to a vertical center of the mounting wall 12 of the flip rail 10 than the second set of openings 28.

Each set of openings 26, 28 is configured to hold a plurality of rollers 38 of a conveyor system. That is, in a first configuration 34, the rollers 38 are installed in the first set of openings 26 along the length of the rail 10. Conversely, in a second configuration 36, the rollers 38 are installed in the second set of openings 28 along the length of the rail 10.

As shown in FIG. 3, the first configuration 34 orients the flip rail 10 so that the first wall 14 is facing upward to become an upper surface and the second wall 18 is facing downward to become a lower surface. Alternatively, FIG. 5 illustrates the second configuration 36 wherein the flip rail 10 is oriented so that the first wall 14 is facing downward to become a lower surface and the second wall 18 is facing upward to become an upper surface.

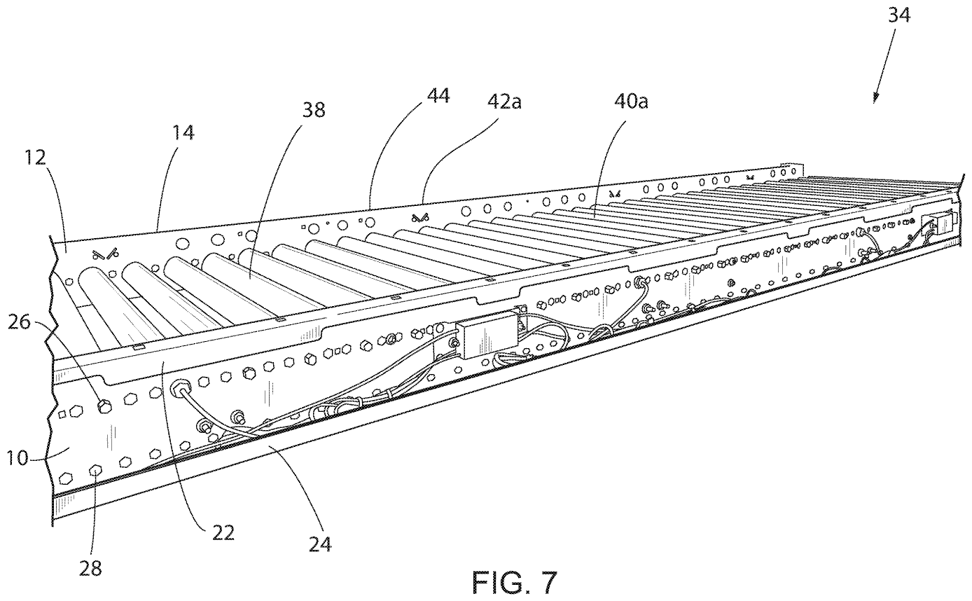

Referring now to FIG. 7, the rail 10 is shown installed in the conveyor system in the first configuration 34 or “high setting”. The conveyor system includes at least two rails 10 disposed opposite each other and preferably, oriented parallel thereto. As shown, the rollers 38 are installed in the first set of openings 26 of each rail 10, while the second set of openings 28 are left empty. The rollers 38 extend between the two rails 10 to provide a conveyor surface. Preferably, the rollers 38 are oriented perpendicular to the rails 10. That is, each roller 38 is preferably installed into aligned openings 26 of the rails 10 in order to orient the roller 38 perpendicularly to the rails 10.

Due to the first set of openings 26 being spaced apart from the first end 16 of the mounting wall 12 by a distance greater than the diameter of the rollers 38, a top surface 40a of the rollers 38 is spaced below a top edge 42a of the rail 10 when installed in the first configuration 34. In the first configuration 34, the top edge 42a of the rail 10 is aligned with the surface 44 of the top wall 14. As a result, the mounting wall 12 is able to function as a guard rail for the resulting conveyor system. Preferably, the first set of openings 26 are spaced from the first end 16 of the mounting wall 12 at a distance greater than 2 inches to provide for a distance between the top edge 42a of the rail 10 in the first configuration 34 and the top surface 40a of the rollers 38 being 1 to 2 inches.

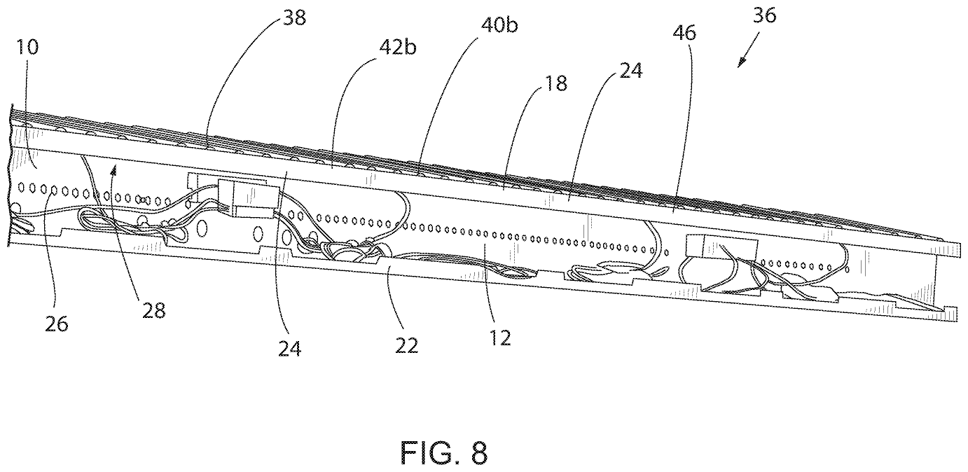

Referring now to FIG. 8, the rail 10 is shown installed in the second configuration 36 or “low setting”. Once again, the conveyor system includes at least two rails 10 disposed opposite each other and preferably, oriented parallel thereto. As shown, the rollers 38 are installed in the second set of openings 28, while the first set of openings 26 are left empty. The rollers 38 extend between the two rails 10 to provide a conveyor surface. Preferably, the rollers 38 are oriented perpendicular to the rails 10. That is, each roller 38 is preferably installed into aligned openings 28 of the rails 10 in order to orient the roller 38 perpendicularly to the rails 10.

Due to the second set of openings 28 being spaced apart from the second end 20 of the mounting wall 12 by a distance less than or equal to the diameter of the rollers 38, a top surface 40b of the rollers 38 is spaced at or above a top edge 42b of the rail 10 when installed in the second configuration 36. In the second configuration 26, the top edge 42b of the rail 10 is aligned with the surface 46 of the bottom wall 18. As a result, the mounting wall 12 does not act as a guard rail or interfere with lateral movement of items on the conveyor system. In turn, a user is able to install separate guard rails to the rail 10. In the representative embodiment of the invention, the top edge 42b is shown below the top surface 40b of the rollers 38.

As shown in FIGS. 7 and 8, the rail 10 is easily flipped between the first configuration 34 and the second configuration 36 for installation in the conveyor system. As such, the conveyor system may easily be transitioned from a conveyor system with the rail 10 acting as a guide to a conveyor system with the rail 10 not acting as a guide and vice versa without the need for further parts or additional rails. That is, only one flip rail 10 design is needed for installation of two different conveyor systems, which reduces the number of parts needed.

FIGS. 7 and 8 further illustrates that the resulting spacing between the mounting wall 12 and the top and bottom walls 14, 18 discussed above with respect to the C-shape of the rail 10 provides for protection of an end of the rollers 38. That is, the rollers 38 extend from the rail 10 in a direction opposite the extension of the top and bottom walls 14, 18 from the mounting wall 12. Meanwhile, the fastener that secures the rollers 38 to the mounting wall 12 are disposed on the opposite side of the mounting wall 12 from the direction in which the rollers 38 extend. These fasteners are in turn protecting by the resulting spacing between the mounting wall 12 and the top and bottom walls 14, 18.

Although the best mode contemplated by the inventors of carrying out the present invention is disclosed above, practice of the present invention is not limited thereto. It will be manifest that the various additions, modifications, and rearrangements of the features of the present invention may be made without deviating from the spirit and scope of the underlying inventive concept.

Moreover, the individual components need not be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

We claim:

1. A rail for a conveyor system having rollers, the rail comprising:
a mounting wall including:
a first set of openings formed adjacent a first edge of the mounting wall at a distance greater than a diameter of the rollers of the conveyor system, the first set of openings configured to exclusively receive the rollers of the conveyor system in a first configuration of the rail;
a second set of openings formed adjacent a second edge of the mounting wall at a distance less than or equal to the diameter of the rollers of the conveyor system, the second set of openings configured to exclusively receive the rollers of the conveyor system in a second orientation of the rail;
a first wall extending outward from the first edge of the mounting wall; and
a second wall extending outward from the second edge of the mounting wall.

2. The rail of claim 1, wherein the first wall is oriented upward and the second wall is oriented downward in the first configuration; and
wherein the second wall is oriented upward and the first wall is oriented downward in the second configuration.

3. The rail of claim 2, wherein a top surface of the rollers is disposed below a top surface of the first wall in the first configuration.

4. The rail of claim 2, wherein a top surface of the rollers is disposed above a top surface of the second wall in the second configuration.

5. The rail of claim 1, wherein the first set of openings are formed at a distance of greater than 2 inches from the first edge of the mounting wall.

6. The rail of claim 1, wherein the second set of openings are formed at a distance less than 1 inch from the second edge of the mounting wall.

7. The rail of claim 1, further comprising a first extension wall extending perpendicular from a cantilevered end of the first wall in a direction toward the second wall and a second extension wall extending perpendicular from a cantilevered end of the second wall in a direction toward the first wall, wherein the second and first extensions walls are oriented parallel to each other.

8. A method of installing a conveyor system, the method including:
installing a plurality of rails, each rail including:
a mounting wall having a first wall extending from a first edge and a second wall extending from a second edge;
a first set of openings formed in the mounting wall adjacent a first edge of the mounting wall at a distance greater than a diameter of rollers of the conveyor system;
a second set of openings formed in the mounting wall adjacent a second edge of the mounting wall at a distance less than or equal to the diameter of the rollers of the conveyor system;
in a first configuration, installing a plurality of rollers of the conveyor system exclusively in the first set of openings; and
in a second configuration, installing the plurality of rollers of the conveyor system exclusively in the second set of openings.

9. The method of claim 8, further comprising, in the first configuration, installing the plurality of rails with the first wall oriented upward and the second wall oriented downward; and
in the second configuration, installing the plurality of rails with the second wall oriented upward and the first wall oriented downward.

10. The method of claim 8, wherein installing the plurality of rollers of the conveyor system in the first configuration comprises extending the plurality of rollers between adjacent rails.

11. The method of claim 10, wherein installing the plurality of rollers of the conveyor system in the first configuration further comprises extending each roller of the plurality of rollers between aligned openings in the first set of openings to orient the rollers perpendicular to the adjacent rails.

12. The method of claim 8, wherein installing the plurality of rollers of the conveyor system in the first configuration comprises extending the plurality of rollers between adjacent rails.

13. The method of claim 12, wherein installing the plurality of rollers of the conveyor system in the first configuration further comprises extending each roller of the plurality of rollers between aligned openings in the second set of openings to orient the rollers perpendicular to the adjacent rails.

14. A conveyor system comprising:
a plurality of rollers;
at least two rails, each rail including:
a mounting wall including:
a first set of openings formed adjacent a first edge of the mounting wall at a distance greater than a diameter of the plurality of rollers of the conveyor system, the first set of openings configured to exclusively receive the plurality of rollers of the conveyor system in a first configuration of the rail;
a second set of openings formed adjacent a second edge of the mounting wall at a distance less than or equal to the diameter of the plurality of rollers of the conveyor system, the second set of openings configured to exclusively receive plurality of the rollers of the conveyor system in a second orientation of the rail;
a first wall extending outward from the first edge of the mounting wall; and
a second wall extending outward from the second edge of the mounting wall;
wherein the plurality of rollers extend between adjacent rails.

15. The conveyor system of claim 14, wherein the first wall of each rail is oriented upward and the second wall of each rail is oriented downward in the first configuration; and
wherein the second wall of each rail is oriented upward and the first wall of each rail is oriented downward in the second configuration.

16. The conveyor system of claim 15, wherein a top surface of the first wall of each rail is located above a top surface of the rollers in the first configuration.

17. The conveyor system of claim 16, wherein the top surface of the first wall of each rail is located above the top surface of the rollers in the first configuration by 1 to 2 inches.

18. The conveyor system of claim 15, wherein a top surface of the second wall of each rail is locate below a top surface of the rollers in the second configuration.

19. The conveyor system of claim 14, wherein, in the first configuration, each roller of the plurality of rollers extends between aligned openings in the first set of openings to orient the rollers perpendicular to the adjacent rails.

20. The conveyor system of claim 14, wherein, in the second configuration, each roller of the plurality of rollers extends between aligned openings in the second set of openings to orient the rollers perpendicular to the adjacent rails.
